(19) United States
(12) Patent Application Publication
(10) Pub. No.: US 2016/0367916 A1
(43) Pub. Date: Dec. 22, 2016

(54) METHOD AND APPARATUS FOR MANUFACTURING A FLUID TREATMENT ELEMENT

(71) Applicant: BRITA GMBH, Taunusstein (DE)

(72) Inventor: André KOEHLER, Deesen (DE)

(73) Assignee: BRITA GMBH, Taunusstein (DE)

(21) Appl. No.: 14/901,932

(22) PCT Filed: Jul. 8, 2014
(86) PCT No.: PCT/EP2014/064502

§ 371 Date: Dec. 29, 2015

(30) Foreign Application Priority Data
Jul. 9, 2013 (EP) 13175809.6

(51) Int. Cl. B01D 29/01; B26F 3/08; B01D 39/16; B26F 1/44

(52) U.S. Cl. CPC B01D 29/012; B26F 1/44; B26F 3/08; B01D 39/1692; B26F 2001/4472; B01D 2239/086; B01D 2239/10; B01D 2239/1216

(57) ABSTRACT

A method of manufacturing porous fluid treatment elements includes forming a planar structure including a layer of thermally bonded particulate material. The fluid treatment elements are cut from the planar structure. Cutting a fluid treatment element from the planar structure includes moving a cutting tool part in an axial direction relative to the planar structure. The cutting tool part includes a cutting edge defining an edge of an orifice delimited by an inner tool surface extending from the cutting edge. At least a section of the inner tool surface is angled with respect to the axis of movement, such that a size of the orifice decreases in axial direction away from the cutting edge.

The invention relates to a method of manufacturing porous fluid treatment elements, including:
forming a planar structure including a layer of thermally bonded particulate material; and
cutting the fluid treatment elements from the planar structure,
wherein cutting a fluid treatment element from the planar structure includes moving a cutting tool part in an axial direction relative to the planar structure, and
wherein the cutting tool part includes a cutting edge defining an edge of an orifice delimited by an inner tool surface extending from the cutting edge.

The invention also relates to a cutting tool for use in such a method.

The invention also relates to an apparatus for manufacturing porous fluid treatment elements, including:
an apparatus for forming a planar structure including a layer of thermally bonded particulate material and
a cutting device for cutting at least one fluid treatment element from the planar structure,
wherein the cutting device is arranged to move a cutting tool part in an axial direction relative to the planar structure, and
wherein the cutting tool part includes a cutting edge defining an edge of an orifice delimited by an inner tool surface extending from the cutting edge.

WO 2012/175656 A1 discloses an apparatus for manufacturing planar multi-layered filter elements that are self-supporting structures and can be inserted into a holder of a filter system in order to treat fluids, in particular liquids such as water. The apparatus comprises an apparatus for providing a support surface in the form of a main endless belt on support drums. A device is provided for depositing a first layer comprising particulate matter comprising at least a binder over a region of the main endless belt. The particulate matter comprises at least particles of a binder material. Two layers are applied, and the double-layered structure is subjected to at least a heat treatment in a double-belt press. As an optional feature, webs of semi-permeable material are provided on either side of the layered structure. A cutting device is used to cut sheets from the layered structure as it reaches the end of the main endless belt. The cut sheet is transferred to a die and punch device that punches the filter elements from the sheet. The remainder of the sheet can be ground and processed to be reused.

A problem occurring when cutting the filter elements from the sheet using conventional die cutters is that the resulting filter elements are vulnerable to abrasion.

It is an object of the invention to provide a method, apparatus and fluid treatment element resulting in fluid treatment elements less likely to give off particles of material.

This object is achieved according to a first aspect by the method according to the invention, which is characterised in that at least a section of the inner tool surface is angled with respect to the axis of movement, such that a size of the orifice decreases in axial direction away from the cutting edge.

At least one of the inner and the outer cutting surfaces must be at an angle to provide a shearing effect. Because the inner cutting surface is at an angle such that a size of the orifice decreases in a direction away from the cutting edge, material is moved inwards inside the orifice. This produces the required shearing effect but also has the effect of compressing the porous material at the outer edge of the fluid treatment element. Thus, the angled section has a sufficient axial extent and is moved through the planar structure to compress an outer region of part of the planar structure entering into the orifice. This compression is useful in fluid treatment elements in which the intended direction of flow is parallel to the direction of movement of the cutting tool relative to the fluid treatment element. Less fluid will flow out through the surface that contacted the inner cutting surface in the cutting operation. Furthermore, the compressive effect results in a smoother surface of the fluid treatment element with a lower risk of particles becoming detached during later handling of the fluid treatment element, including in the fluid treatment device for which it is intended. A further effect is that an outer surface of the cutting tool part extending from the cutting edge in axial direction can have a much smaller angle to the axis, indeed be essentially straight. This allows the fluid treatment elements to be die-cut at a relatively small spacing from the planar structure, because material is not forced away from the cutting tool part in the plane of the sheet.

The planar structure is one of a sheet, plate or web of thermally bonded particulate material. It may comprise only binder in particulate form or a mixture of binder and other types of particulate material. Particulate material includes material in powder form, the grain size being chosen in dependence on the desired pore size. Being fluid treatment elements and made of a layer of thermally bonded particulate material, it goes without saying that the fluid treatment elements, including in particular the layer or layers of thermally bonded particulate material, are permeable to fluid.

The method may be used to produce planar fluid treatment elements. These have major surfaces facing in opposite directions and having lateral dimensions from edge to edge at least ten times the thickness (maximum value of the shortest distance from any point on one major surface to a point on the opposite major surface) of the fluid treatment element. When placed in a holder of a fluid treatment element, sealing is generally accomplished by pressing the fluid treatment element down into the holder by a force directed essentially perpendicularly to the upstream major surface. This is thus the direction in which the fluid treatment elements are compressed in use, if at all. Furthermore, when transported, such fluid treatment elements are generally supported on their major surfaces or stacked to leave the lateral surfaces and edges exposed. Preventing abrasion of these surfaces and edges is thus of especial use.

In the method, the angled section of the inner tool surface has a sufficient extent and is moved through the planar structure to compress an outer region of the planar structure entering the orifice.

In an embodiment, the angle has a value between 5° and 30°, e.g. 15°.

This embodiment has been found to result in adequate compression of the outer region of the fluid treatment elements. The angle is still small enough to provide relatively straight sides to the fluid treatment elements. Moreover, the angle is small enough to limit wear of the cutting tool part. The cutting tool part will have only a short useful lifetime if the angle is more than 30°. 15° has been found to result in an acceptable useful lifetime of the cutting tool part.

In an embodiment, the size reduction corresponds to a reduction in at least one dimension of at least 2 mm, e.g. 3 mm or more.

This ensures sufficient compression of the outer region of the fluid treatment element, even where it is cut from a relatively elastic planar structure. The dimension would correspond to the diameter of a circular shape or of the lengths of the sides of a quadrilateral orifice.

In an embodiment, an edge of the angled section of the inner tool surface furthest removed in axial direction from the cutting edge adjoins one of an undercut and a section of the inner tool surface essentially parallel to the axis of movement.

By advancing this edge completely through the thickness of the planar structure, fluid treatment elements with lateral surfaces essentially perpendicular to their major surfaces can be manufactured.

In a variant of this embodiment, the angled section has a sufficient extent and is advanced completely through the thickness of the planar structure to compress an outer region of the planar structure entering the orifice.

Thus, fluid treatment elements having lateral surfaces essentially perpendicular to the major surfaces are produced. They are densified in the region of these surfaces relative to regions inside the fluid treatment elements further removed from the lateral surfaces.

In an embodiment, the cutting tool part has an outer tool surface extending away from the cutting edge, the inner and outer tool surfaces forming opposite surfaces of a cutting blade.

The cutting tool part is thus configured like a die cuter or cookie cutter. The fluid treatment element is separated cleanly from the planar structure.

In a variant of this embodiment, the outer tool surface includes at least a section, seen in axial direction, at a smaller angle with respect to the axis than a corresponding section of the inner tool surface.

To provide adequate separation, at least one of the inner and outer tool surfaces must be at an angle. In this variant, the inner surface is at an angle, whereas the outer tool surface can be more or less parallel to the axis (the stroke direction). As a result, fluid treatment elements can be cut at a smaller mutual spacing from the planar structure. More of it is used to produce fluid treatment elements. Material is not pushed radially outwards with respect to a central axis of the orifice, which would require a higher spacing to be used in order to generate fluid treatment elements with generally flat major surfaces.

In a particular variant therefore, the angle smaller than the angle of the corresponding section of the inner tool surface is smaller than 5°, e.g. about 0°, at every axial position within the section.

It is noted that the section of the outer tool surface may be contiguous to a facet angled with respect to the axis and extending up to the cutting edge. This leads to a sharper cutting edge. Where the outer tool surface is provided with a facet at an angle with respect to the axis and extending essentially to the cutting edge, the axial extent of the angled section of the inner tool surface is a multiple of the axial extent of the facet, for example a multiple of at least ten, more generally at least one hundred. Such a facet functions to provide a sharp cutting edge but has too small an axial extent to compress the planar structure to any appreciable degree when the cutting edge is advanced into the planar structure. This is useful, because multiple fluid treatment elements can thus be cut from a single planar structure at a smaller spacing, leading to less waste.

In an embodiment, the cutting edge extends in a round, e.g. circular, shape.

Thus, planar fluid treatment elements with major surfaces having a round, e.g. circular shape can be formed. Each next element must be cut from the planar structure at a certain distance to an adjacent hole where a fluid treatment element has previously been cut out. The distance can be smaller in this embodiment.

In an alternative, multiple fluid treatment elements are cut from the planar structure in parallel by respective cutting tool parts, each including a cutting edge defining an edge of a respective orifice, wherein a section of a cutting edge defining an edge of an orifice also forms a section of a cutting edge defining an edge of an adjacent orifice.

Thus, the manufacturing process is speeded up. All fluid treatment elements are of similar configuration, including those cut by cutting tool parts at the edge of the tool. They may have any shape suitable for tiling a surface, e.g. quadrilateral or hexagonal.

In an embodiment, at least part of the cutting tool part is heated.

This has the effect of producing even smoother lateral surfaces, since the region that is compressed is also heated slightly. The (thermoplastic) binder at this surface becomes soft or even liquid, and is spread across the surface. In use in a fluid treatment device, the fluid treatment element is held in a holder and the fluid flow is in the axial direction, perpendicular to the surface approached by the cutting tool part during manufacturing. Lateral outflows of fluid are not desirable, so that a reduction in the porosity of the region at the lateral surface or even a closing of the lateral surface due to a smearing out of the binder is, if anything, of benefit.

In an embodiment, the fluid treatment elements are cut from the planar structure whilst at a temperature above ambient temperature.

Thus, at least the section of the planar structure that the cutting tool part approaches and enters is at the elevated temperature. It has been found that the thermally bonded material is slightly elastic in this state. Some of the compression is therefore reversed upon separation of the fluid treatment element from the planar structure. As a result, more fluid treatment elements of a required lateral dimension can be cut from a planar structure with a given surface area. In a variant, the binder is a thermoplastic binder and the temperature is close to the melting point, e.g. no more than 20° C. below the melting temperature. The porosity of the lateral region of the fluid treatment element is reduced due to the compression brought about by the inclined inner tool surface.

In an embodiment, a web of semi-permeable material is applied to form a surface of the planar structure on the side from which the cutting edge approaches the planar structure.

This embodiment helps prevent particle loss from a surface not densified by the inner tool surface. If, in use, this is the surface through which treated fluid leaves the fluid treatment element, it can be prevented that loose particles are entrained by the fluid. The web is permeable to the fluid but impermeable to particles above a certain size. It may be made of a woven or non-woven textile, e.g. a mesh or fleece. The cutting edge of the cutting tool part cuts a piece from the web. The edge of this piece is pulled along by the inclined inner tool surface. As a result, the fluid treatment element has a circumferential edge that is protected by the piece cut from the web. It cannot become chipped during handling of the fluid treatment element.

In a variant, a web of semi-permeable material is applied to form an opposite surface of the planar structure.

Thus, the fluid treatment element can be used in a fluid treatment device with either side facing downstream. Inappropriate use is prevented. Also, abrasion is prevented more effectively, since every surface is either a surface formed by the layer of thermally bonded material that has been exposed to the inclined inner tool surface or a surface formed by a piece from a web of semi-permeable material.

In an embodiment, an ejector is provided within the orifice and the ejector is used to move the fluid treatment element out of the orifice of the cutting tool part.

In one variant, the ejector is an elastic structure, which is compressed as the cutting tool part advances into the planar structure and ejects the fluid treatment element from the orifice by relaxing as soon as the fluid treatment element has been separated from the remainder of the planar structure. In another embodiment, the ejector includes a support device movable within the orifice, wherein at least one of the cutting tool part and the support device is driven by an actuator to move it relative to the other.

In an embodiment, the cutting tool part is advanced only part-way through a thickness of the planar structure, and a further cutting tool part as defined above is advanced into the planar structure from an opposite side.

As a result both edges of the fluid treatment element where the lateral surface joins an end surface are relatively smooth. There is a reduced likelihood of chipping during handling. In case both surfaces of the planar structure are formed from a web of semi-permeable material, it is prevented that the cutting tool part strips off the web as its leading edge emerges. Rather, smooth edges covered by a respective one of the webs are formed on both sides of the fluid treatment element.

In a variant combining the two aforementioned embodiments, the ejector is used to move the fluid treatment element further into the orifice of the further cutting tool part.

Thus, there is provided a fluid treatment element with a relatively straight lateral surface.

In an embodiment, the layer of thermally bonded material includes material for the treatment of liquid by sorption, e.g. activated carbon.

This is a useful application of the manufacturing method. The activated carbon can include relatively small particles or powder (even if only unintentionally).

In an embodiment, the layer of thermally bonded material includes particulate binder, in particular a thermoplastic binder, more particularly a high-molecular weight or ultra-high molecular weight polyethylene binder.

This is a useful application of the manufacturing method. The planar structure is sintered at an elevated temperature with relatively little pressure. The pressure that is applied determines the porosity to a large extent.

According to another aspect, the cutting tool for use in a method according to the invention includes a cutting tool part including a cutting edge defining an edge of an orifice delimited by an inner tool surface extending from the cutting edge, wherein at least a section of the inner tool surface is at an angle to a central axis of the orifice, such that a size of the orifice decreases in axial direction away from the cutting edge.

The angled section may have a sufficient extent to compress an outer region of a planar structure with a thickness of at least 2 mm, in one embodiment at least 4 mm, when the planar structure enters the orifice completely.

The angle may have a value between 5° and 30°.

An edge of the angled section of the inner tool surface furthest removed in axial direction from the cutting edge may adjoin one of an undercut and a section of the inner tool surface essentially parallel to the central axis.

According to another aspect, the apparatus for manufacturing porous fluid treatment elements according to the invention is characterised in that at least a section of the inner tool surface is at an angle to the axis of movement, such that a size of the orifice decreases in axial direction away from the cutting edge.

In an embodiment, the apparatus is configured for manufacturing fluid treatment elements by means of a method according to the invention.

The cutting tool included in the apparatus may be a cutting tool according to the invention.

The invention will be explained in further detail with reference to the accompanying drawings, in which:

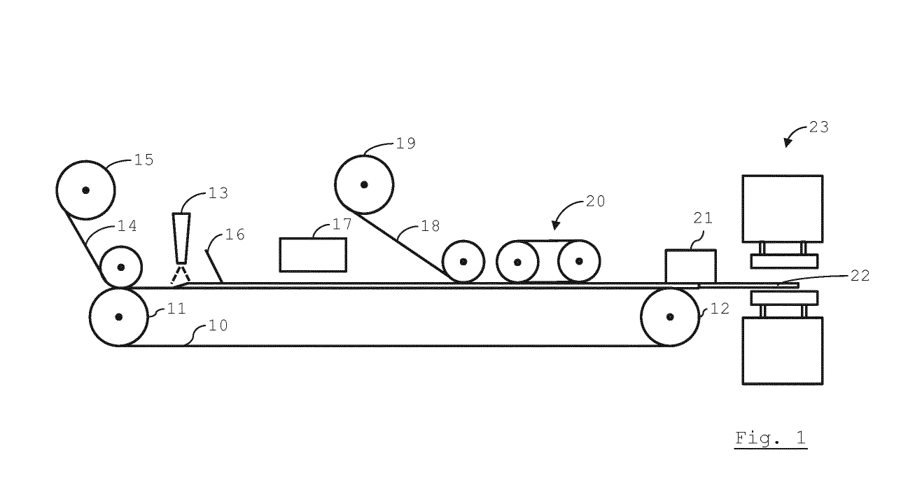

FIG. 1 is a diagram of an apparatus for manufacturing fluid treatment elements;

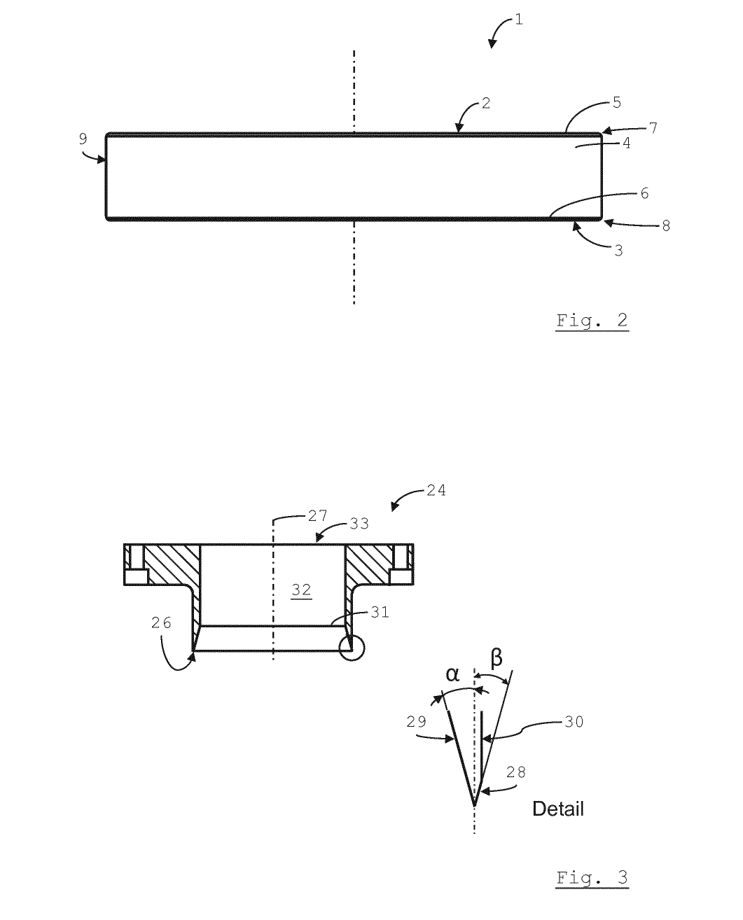

FIG. 2 is a schematic cross-sectional diagram of a fluid treatment element obtainable using the apparatus;

FIG. 3 is a cross-section of a cutting tool part;

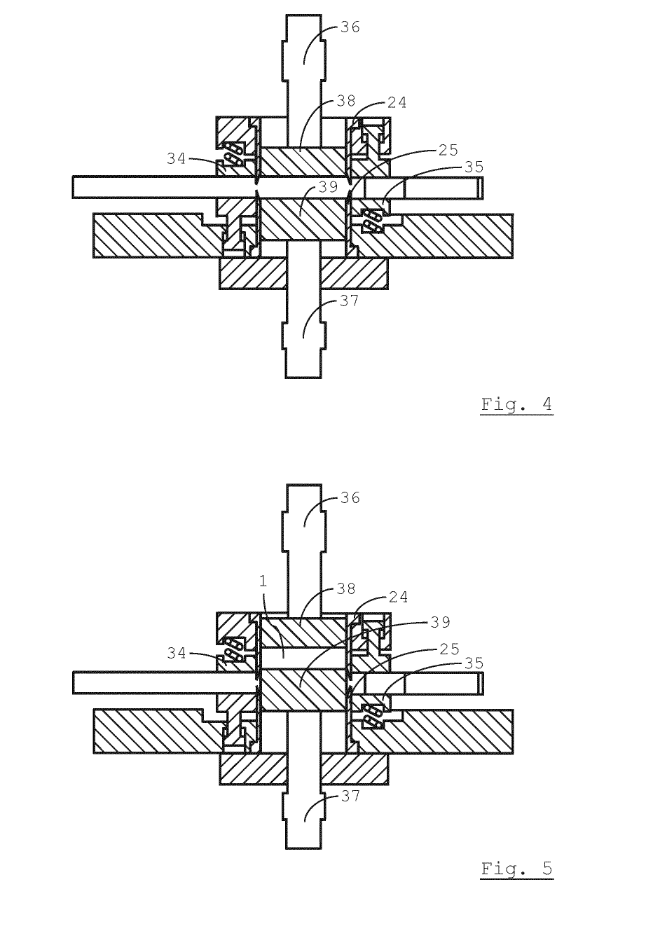

FIG. 4 is a cross-sectional view of an apparatus for obtaining a fluid treatment element at a first stage of its operation;

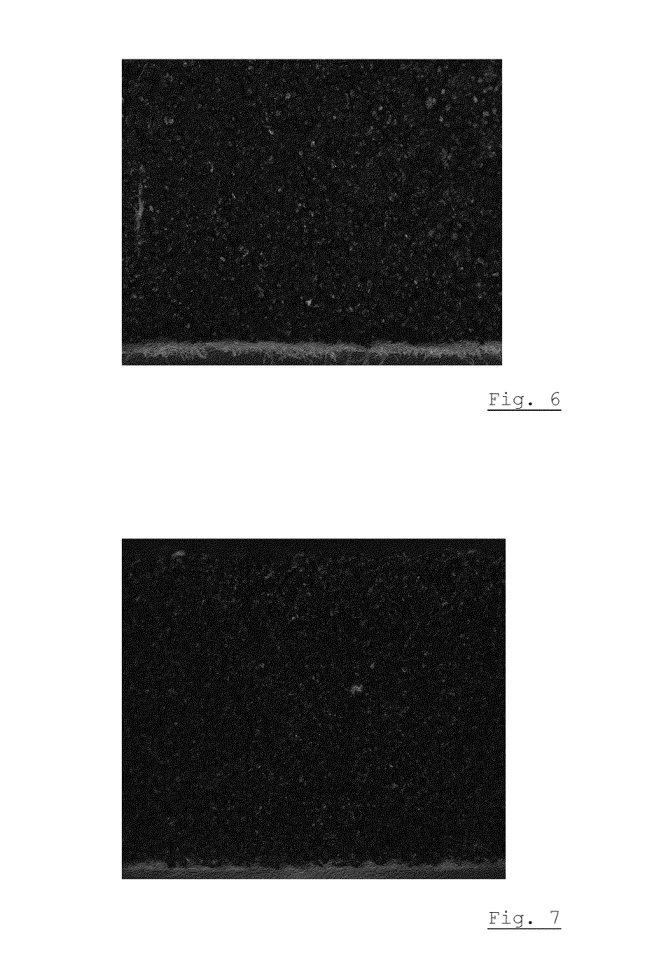

FIG. 5 is a cross-sectional view of the apparatus of FIG. 4 at a second stage of its operation;

FIG. 6 is a photographic image of a lateral surface of an actual fluid treatment element obtained using a method similar to that performed by the apparatus;

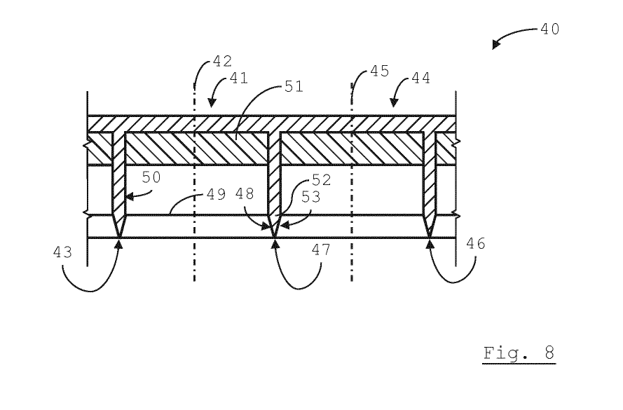

FIG. 7 is a photographic image of a lateral surface of an actual fluid treatment element obtained using a different method for comparison; and

FIG. 8 is a cross-section of part of a tool for obtaining rectangular, square or hexagonal planar fluid treatment elements.

The invention will be explained using the example of an apparatus (FIG. 1) for manufacturing fluid treatment elements 1 (FIG. 2) for use in filtering liquids, in particular water. The fluid treatment elements 1 are planar, having lateral dimensions at least twice their thickness. They are intended to treat liquid flowing through the thickness of the fluid treatment elements 1, in use. For this purpose, a fluid treatment device (not shown) includes a holder for receiving such a fluid treatment element 1 in a sealing manner, such that the fluid to be treated is forced to enter the fluid treatment element 1 through one major surface 2 and leave the fluid treatment element through the opposite major surface 3.

Typical thicknesses are within the range of at least 4 mm and at most 40 mm, in particular less than 20 mm.

In the illustrated embodiment, the fluid treatment element 1 includes a single porous layer 4 of thermally bonded particulate material. Both surfaces 2,3 are formed by pieces 5,6 of semi-permeable material. This material is generally a piece of woven or non-woven textile, e.g. a mesh or fleece, for example a non-woven made of point-bonded polypropylene or polyethylene.

The major surfaces 2,3 are essentially flat, at least up to close to their edges 7,8.

Instead of a single porous layer 4, alternative embodiments may comprise multiple porous layers differing in at least one of composition, porosity, pore size and distribution of one of these parameters.

The porous layer 4 of the example has a substantially uniformly distributed porosity and pore size, except in a region near a lateral surface 9, where the porosity and pore size are lower. In the majority of the porous layer 4, the porosity has a value larger than 20%, in particular larger than 30%, more particular larger than 40%. It can have a value smaller than 80%, in particular smaller than 70%, more particularly smaller than 60%. Typically, the average pore size will be larger than 2 μm, in particular larger than 5 μm. The average pore size will be smaller than 100 μm, in particular smaller than 70 μm, more particularly smaller than 50 μm.

In the examples to be discussed herein, the porous layer 4 is made of thermally bonded particulate material. The material includes both a binder and an active material, in particular a sorbent. Examples include activated carbon, heavy metal sorbents ion exchange materials, chelating agents and the like. In other embodiments, the fluid treatment element includes a component that leaches into the fluid to be treated as it passes through the fluid treatment element 1.

The binder is a material that binds other particles when subjected to heat or radiation of another form. In the examples to be discussed herein, the binder is a thermoplastic binder, for example an ultra-high-molecular-weight polyethylene or high-density polyethylene. The melting point (as determined using differential scanning calorimetry) of the binder is at least 120° C., e.g. in the range of 120-150° C. and it is thermally stable up to at least 300° C. The particle size of the binder material can be of the order of 10-1000 μm, for example. The particles of binder material may have an average diameter larger than that of the particles of active material. Thus, they increase the pore size without reducing the available surface of the active material.

The apparatus for manufacturing fluid treatment elements (FIG. 1) includes a main endless belt 10 on support drums 11,12 of which at least one is driven by an electric motor (not shown). A device 13 for depositing a layer comprising particulate material including at least the binder particles and the particles of active material onto a lower web 14 of semi-permeable material supported by the main endless belt 10 is provided. The particles are deposited in dry form in the example, but may be sprayed on in an alternative embodiment. The dry form is more energy-efficient. The lower web 14 is unwound from a reel 15.

A doctor blade 16 sets the thickness of the layer. A device 17 for applying heat to an upper surface of the layer of particulate material applies heat in a contactless manner. This enables the application of an upper web 18 of semi-permeable material from a further reel 19 in such a manner that the upper surface 2 of the fluid treatment element 1 is relatively smooth and free from wrinkles. In an alternative embodiment, the device 17 may be omitted.

The layered structure resulting upon application of the upper web 18 is then heated in a double-belt press 20 to a temperature higher than the melting point of the thermoplastic binder. The heated surfaces in contact with the layered structure have a temperature of the order of 50° C. above the melting point of the thermoplastic binder in one embodiment. The double-belt press 20 is used to improve the transfer of heat to the structure. The pressure applied by the double-belt press 20 is minimal, e.g. below 5000 Pa.

A cutting device 21 cuts a plate 22 from the layered structure before it can cool down to ambient temperature. The plate is then transferred to a cutting apparatus 23 for cutting fluid treatment elements 1 from the plate 22. It is noted that the cutting device 21 is optional. In another embodiment, the fluid treatment elements are obtained directly from the layered structure. For example, rows of fluid treatment elements 1 may be cut from the layered structure as it emerges from the double-belt press 20.

In the illustrated embodiment, die cutting tools are advanced into the plate 22 from both sides. It is also possible partially to stamp out the fluid treatment elements from one side and then turn the plate 22 over to stamp the fluid treatment elements 1 out completely.

Generally, multiple fluid treatment elements 1 will be cut from the plate 22 in parallel. FIGS. 3-5 illustrate a prototype cutting apparatus 23 for stamping out a single fluid treatment element 1, however. It will be apparent that the components of the cutting apparatus 23 replicated and arranged in an array to cut out multiple fluid treatment elements 1 in one stroke.

The cutting apparatus 23 includes an upper and a lower cutting tool part 24,25. FIG. 3 shows the upper cutting tool part 24, but the two are identical in shape and dimensions. Electric coils or thermoelectric heating devices (not shown) may be provided to heat the cutting tool parts 24,25.

The cutting tool part 24 is provided with a cutting edge 26 defining an edge of an orifice. The cutting edge 26 is closed on itself around a central axis 27 of the orifice. The central axis 27 is essentially aligned with the axis of movement of the cutting tool part 24 in the cutting apparatus 23. In the illustrated embodiment, the cutting edge 26 is round, in particular circular. The cutting tool part 24 has an outer tool surface including an angled facet 28 for providing a sharp cutting edge 26 and an outer tool surface section 30 that is essentially parallel to the central axis 27. The facet 28 is at an angle β with respect to the central axis 27. This angle β has a value higher than about 5°. An upper limit to the angle β is about 30°. A value within the range of 10-20° has been found to be quite suitable.

The orifice is delimited by an inner tool surface comprising, in this example, an angled section 29 extending in axial direction from the cutting edge 26 to an opposite edge 31 and an adjoining straight section 32 that extend in axial direction to an aperture 33 at an axial end of the cutting tool part 24.

The angled section 29 is at an angle α with respect to the central axis 27. The angle α has a value higher than about 5°. An upper limit to the angle α is about 30°. A value within the range of 10-20° has been found to be quite suitable, with about 15° providing sufficient functionality and an acceptable rate of abrasion of the angled section 29 and dulling of the cutting edge 26. The angle α is thus such as to reduce the diameter of the orifice, seen in axial direction from the cutting edge 26 into the orifice. The axial extent of the angled section 29 is such as to provide a diameter reduction of at least 2 mm, e.g. 3 mm or more.

Turning now to FIGS. 4 and 5, the cutting apparatus 23 includes a clamping arrangement including upper and lower biased supports 34,35, mounted to the cutting tool parts 24,25. Ejectors including actuated pistons 36,37 and inner supports 38,39 are arranged to allow the inner supports 38,39 to be moved within the respective orifices.

With the plate 22 still at an elevated temperature relative to ambient temperature, the upper and lower cutting tool parts 24,25 are advanced from respective sides into the plate 22. Their central axes 27 are aligned, but the distances over which they are advanced are insufficient for the cutting edges 26 to contact each other. The clamping arrangement supports the outer region of the plate 22 and the inner supports 38,39 are applied against the part of the plate 22 entering part-way into the orifices. The axial extent of the angled sections 29 of each cutting tool part 24,25 is less than half the thickness of the plate 22. To provide a straight lateral surface 9 and completely separate the fluid treatment element 1 from the remainder of the plate 22, the lower inner support 39 is used to move the nearly separated fluid treatment element 1 out of the orifice of the lower cutting tool part 25 and further into the orifice of the upper cutting tool part 24. The fluid treatment element 1 is moved completely past the inner edge 31 of the angled section 29 of the inner tool surface of the upper cutting tool part 24, as shown in FIG. 5.

Then, the upper part of the cutting apparatus 23 is lifted off the plate 22, so that the remainder of the plate 22 can be removed from the cutting apparatus 23. The fluid treatment element 1 is then ejected by moving the upper inner support 38 within the orifice of the upper cutting tool part 24. A sweeping or other collecting device (not shown) can be used to collect the fluid treatment element 1 without human intervention.

Due to the angled section 29 of the upper and lower cutting tool parts 24,25, the lateral surface 9 is less permeable to the fluid to be treated. FIG. 6 is a photographic image showing the lateral surface as obtained using the cutting apparatus 23 described above, whereas FIG. 7 shows the lateral surface of a fluid treatment element obtained using a cutting tool part of which the inner and outer tool surface had the inverse configuration (i.e. the outer tool surface included a relatively large angled section). The larger dark surface shown in FIG. 7 illustrates that a higher fraction of the area is occupied by pore openings.

A simple alternative cutting apparatus includes a cutting tool 40 as illustrated schematically in FIG. 8. This cutting tool 40 can be used to cut multiple fluid treatment elements from a plate 22 of thermally bonded particulate material in one stroke with relatively little waste. This effect is due to, amongst others, the shape of the fluid treatment elements.

A first cutting tool part 41 is arranged about a first central axis 42. This tool part 41 includes a first cutting edge 43 having a quadrilateral shape. An adjacent second cutting tool part 44 is arranged about a second central axis 45 and has a second cutting edge 46 with a similar shape. The first and second cutting edges 43,46 have a section 47 in common.

The first cutting edge 43 defines an edge of a first orifice delimited by in an inner tool surface extending from the first cutting edge 43. The inner tool surface includes an angled section 48 that is angled with respect to the first central axis 42 so that the size of the first orifice decreases away from the first cutting edge 43. The angled section extends to an edge 49 furthest removed from the first cutting edge 43 in axial direction. This edge 49 marks a transition to an adjoining straight inner tool surface section 50. An elastic ejection device 51, e.g. a piece of foam, is arranged within the orifice. The axial extent of the straight inner tool surface section 50 is greater than the thickness of the plate 22 or other planar structure form fluid treatment elements are to be cut. Thus, the edge 49 of the angled section 48 can pass through the planar structure with one stroke of the cutting tool 40. The elastic ejection device 51 is configured to be compressed sufficiently to provide an ejecting force on the return stroke, which causes a fluid treatment element in the first orifice to be ejected.

The first angled section 48 has an angle within the ranges indicated above for the angle α of the angled section 29 of the inner tool surface of the upper cutting tool part 24 of the embodiment of FIGS. 3-5. The reduction in the lateral dimension of the first orifice relative to the width of the aperture defined by the first cutting edge 43 is also of the same order.

The angled section 48 of the inner tool surface delimiting the first orifice is provided on an opposite side of a dividing wall section 52 to an angled section 53 of an inner tool surface delimiting the second orifice. This angled section 53 is at a similar angle with respect to the second central axis 45, and has essentially the same axial extent. This axial extent and the corresponding reduction in width of the second orifice are sufficient to compress an outer region of a part of a planar structure entering into the second orifice and forming a fluid treatment element upon separation from the planar structure.

A heating device (not shown) to heat the cutting tool 40 may be provided to allow the cutting tool 40 to be used at an elevated temperature relative to the ambient temperature. In addition, the cutting tool 40 may be used to cut fluid treatment elements from a planar structure formed of thermally bonded particulate material at an elevated temperature relative to room temperature. In one variant, the planar structure is kept at an elevated temperature resulting from its production process. In another variant, the planar structure is (re-)heated prior to applying the cutting tool 40.

A support plate (not shown) may be used to support the planar structure when the cutting tool 40 is advanced into the planar structure. In addition, a clamping apparatus may be used to hold the planar structure against the support plate. The support plate may be provided with grooves having a shape complimentary to that of the cutting edges 43,46 so as not to blunt them when the cutting tool 40 passes completely through the planar structure.

The angled sections 48,53 provide a better finish to the lateral surfaces of fluid treatment elements obtained using the cutting tool 40. There is less risk of abrasion of dust or particles from this surface during handling. Moreover, the surface structure supports the guidance of fluid from one major surface of the fluid treatment element to the other, thus providing relatively uniform treatment of the fluid.

The invention is not limited to the embodiments described above, which may be varied within the scope of the accompanying claims. For example, the porous layer 4 may additionally comprise active material in the form of fibres, including chopped fibres. It may also consist exclusively of binder particles.

A variant of the illustrated method is possible, in which the upper web 18 is applied after the layered structure has passed through the double-belt press 20. Because it may have cooled down somewhat, the upper web 18 is then applied using a heated calender. The layered structure may be maintained at an elevated temperature until the fluid treatment elements 1 have been cut from the layered structure or a plate cut from the layered structure, in this embodiment.

### LIST OF REFERENCE NUMERALS

1—fluid treatment element

2—upper surface

3—lower surface

4—porous layer

5—upper piece of semi-permeable material

6—lower piece of semi-permeable material

7—upper edge of fluid treatment element

8—lower edge of fluid treatment element

9—lateral surface of fluid treatment element

10—main endless belt

11—support drum

12—support drum

13—depositing device

14—lower web of semi-permeable material

15—reel

16—doctor blade

17—heating device

18—upper web of semi-permeable material

19—reel

20—double belt press

21—cutting device

22—plate

23—cutting apparatus

24—upper cutting tool part

25—lower cutting tool part

26—cutting edge

27—central axis

28—facet

29—angled surface section

30—outer tool surface section

31—edge of angled surface section

32—straight tool surface section

33—aperture

34—upper biased support

35—lower biased support

36—upper piston

37—lower piston

38—upper inner support

39—lower inner support

40—cutting tool

41—first cutting tool part

42—first central axis

43—first cutting edge

44—second cutting tool part

45 second central axis

46—second cutting edge

47—common section

48—first angled section

49—angled section edge

50—straight inner tool surface section

51—elastic ejection device

52—dividing wall section

53—second angled section

1. Method of manufacturing porous fluid treatment elements, including: forming a planar structure including a layer of thermally bonded particulate material; and
cutting the fluid treatment elements from the planar structure,
wherein cutting a fluid treatment element from the planar structure includes moving a cutting tool part in an axial direction relative to the planar structure, and
wherein the cutting tool part includes a cutting edge defining an edge of an orifice delimited by an inner tool surface extending from the cutting edge, characterised in that
at least a section of the inner tool surface is angled with respect to the axis of movement, such that a size of the orifice decreases in axial direction away from the cutting edge.

2. Method according to claim 1,
wherein the angle-has a value between 5° and 30°, e.g. 15°.

3. Method according to claim 1,
wherein the size reduction corresponds to a reduction in at least one dimension of at least 2 mm, e.g. 3 mm or more.

4. Method according to claim 1,
wherein an edge of the angled section of the inner tool surface furthest removed in axial direction from the cutting edge adjoins one of an undercut and a section of the inner tool surface essentially parallel to the axis of movement.

5. Method according to claim 1,
wherein the cutting tool part has an outer tool surface extending away from the cutting edge, the inner and outer tool surfaces forming opposite surfaces of a cutting blade.

6. Method according to claim 5,
wherein the outer tool surface includes at least a section, seen in axial direction, at a smaller angle with respect to the axis than a corresponding section of the inner tool surface.

7. Method according to claim 6,
wherein the angle smaller than the angle of the corresponding section of the inner tool surface is smaller than 5°, e.g. about 0°, at every axial position within the section.

8. Method according to claim 7,
wherein the section of the outer tool surface is contiguous to a facet angled with respect to the axis and extending up to the cutting edge.

9. Method according to claim 1, wherein at least part of the cutting tool part is heated.

10. Method according to claim 1,
wherein the fluid treatment elements are cut from the planar structure whilst at a temperature above ambient temperature.

11. Method according to claim 1, wherein an ejector is provided within the orifice and the ejector is used to move the fluid treatment element out of the orifice of the cutting tool part.

12. Method according claim 1,
wherein the cutting tool part is advanced only part-way through a thickness of the planar structure, and
wherein a further cutting tool part as defined in any one of the preceding claims is advanced into the planar structure from an opposite side.

13. Cutting tool for use in a method according to claim 1 including a cutting tool part that includes a cutting edge defining an edge of an orifice delimited by an inner tool surface extending from the cutting edge, wherein at least a section of the inner tool surface is at an angle to a central axis-of the orifice, such that a size of the orifice decreases in axial direction away from the cutting edge.

14. Apparatus for manufacturing porous fluid treatment elements, including:
an apparatus for forming a planar structure including a layer of thermally bonded particulate material and
a cutting device for cutting at least one fluid treatment element from the planar structure,
wherein the cutting device is arranged to move a cutting tool part in an axial direction relative to the planar structure, and
wherein the cutting tool part includes a cutting edge defining an edge of an orifice delimited by an inner tool surface extending from the cutting edge, characterised in that
at least a section of the inner tool surface is at an angle to the axis of movement, such that a size of the orifice decreases in axial direction away from the cutting edge.

15. Apparatus according to claim 14, configured for manufacturing fluid treatment elements by means of a method according to claim 1.
